(19) United States
(12) Patent Application Publication
(10) Pub. No.: US 2007/0221873 A1
(43) Pub. Date: Sep. 27, 2007

(54) Electromagnetically Driven Valve

(76) Inventors: Yutaka Sugie, Nishikamo-gun (JP); Masahiko Asano, Toyota-shi (JP)

Correspondence Address: KENYON & KENYON LLP, 1500 K STREET N.W., SUITE 700, WASHINGTON, DC, 20005, US

(21) Appl. No.: 11/628,006

(22) PCT Filed: May 19, 2005
(86) PCT No.: PCT/JP05/09607

§ 371 Date: Nov. 30, 2006

(30) Foreign Application Priority Data
Jul. 9, 2004 (JP) 2004-203370

(51) Int. Cl. F16K 31/02

(52) U.S. Cl. 251/129.01

(57) ABSTRACT

An electromagnetically driven valve is actuated by cooperation of electromagnetic force and elastic force. The electromagnetically driven valve includes a driven valve having a stem and carrying out reciprocating motion along a direction in which the stem extends, a lower disc and an upper disc spaced apart from each other and each having one end coupled to the stem so as to allow free oscillation of the disc and the other end supported by a disc base so as to allow free oscillation of the disc, and a lower spring and an upper spring provided at the other end of the lower disc and at the other end of the upper disc respectively and applying elastic force to the lower disc and the upper disc. With such a structure, an electromagnetically driven valve reduced in height and attaining excellent mounting characteristic can be provided.

This is a 371 national phase application of PCT/JP2005/009607 filed 19 May 2005, which claims priority to Japanese Patent Application No. 2004-203370 filed 9 Jul. 2004, the contents of which are incorporated herein by reference.

### FIELD OF THE INVENTION

The present invention generally relates to an electromagnetically driven valve, and more particularly to an electromagnetically driven valve of a rotary drive type used in an internal combustion engine.

### BACKGROUND OF THE INVENTION

As a conventional electromagnetically driven valve, for example, U.S. Pat. No. 6,467,441 specification discloses an electromagnetic actuator actuating valves of an internal combustion engine as a result of cooperation of electromagnetic force and a spring. The electromagnetic actuator disclosed in the specification is called a rotary drive type, and includes a valve having a stem and an oscillating arm having a first end hinged on a support frame and a second end in abutment on the upper end of the stem.

An electromagnet consisting of a magnetic core and a coil wound around the magnetic core is arranged on each opposing side of the oscillating arm. The electromagnetic actuator further includes a torsion bar provided at the first end of the oscillating arm and moving the valve toward a position of maximum opening and a helical spring arranged on an outer circumference of the stem and moving the valve to a closed position. The oscillating arm oscillates with the first end serving as a fulcrum, as a result of the electromagnetic force generated by the electromagnet and elastic force of the torsion bar and the helical spring. The movement of the oscillating arm is transmitted to the stem through the second end, whereby the valve carries out reciprocating motion between the position of maximum opening and the closed position.

In addition, Japanese Patent Laying-Open No. 11-350929 discloses an electromagnetically driven valve called a parallel drive type, which aims to reliably attract an armature to an electromagnet as well as to reduce power consumption. The electromagnetically driven valve disclosed in this publication includes a valve shaft integrally formed with a valve element.

A collar-like armature projecting in a radial direction of the valve shaft is formed on the valve shaft, and a first electromagnet and a second electromagnet are arranged so as to sandwich the armature. The electromagnetically driven valve further includes a lower spring moving the valve element toward the closed position, and an upper spring moving the valve element toward the position of maximum opening, that are arranged in series in an axial direction of the valve shaft. According to the parallel drive type valve, the electromagnetic force generated by the first electromagnet and the second electromagnet as well as the elastic force of the lower spring and the upper spring directly act on the valve shaft, whereby the valve shaft carries out reciprocating motion.

In the electromagnetically driven valve of the parallel drive type disclosed in Japanese Patent Laying-Open No. 11-350929, the lower spring, the upper spring, the first electromagnet, and the second electromagnet are provided in a manner aligned in the axial direction of the valve shaft. Accordingly, the electromagnetically driven valve tends to have a large height. When such an electromagnetically driven valve is used as an intake/exhaust valve in an engine for a vehicle or the like, it is difficult to meet requirements for engine mount height. Meanwhile, according to the electromagnetic actuator of the rotary drive type disclosed in U.S. Pat. No. 6,467,441 specification, the torsion bar is arranged at the second end of the oscillating arm, so that the height of the actuator is suppressed to some extent. On the other hand, as the helical spring is arranged along the stem as in the electromagnetically driven valve disclosed in Japanese Patent Laying-Open No. 11-350929, the height of the actuator is not satisfactorily low.

In addition, according to the electromagnetic actuator disclosed in U.S. Pat. No. 6,467,441 specification, two electromagnets are provided in a manner aligned in the axial direction of the stem. Meanwhile, according to the electromagnetically driven valve disclosed in Japanese Patent Laying-Open No. 11-350929, the first electromagnet and the second electromagnet are provided in a manner aligned in the axial direction of the valve shaft. In this manner, the electromagnets provided for different purposes such as valve-opening and valve-closing respectively have also turned out to be a factor to increase the height of the electromagnetic actuator and the electromagnetically driven valve.

### SUMMARY OF THE INVENTION

The present invention was made to solve the above-described problems, and an object of the present invention is to provide an electromagnetically driven valve having a smaller height and attaining excellent mounting characteristic.

An electromagnetically driven valve according to one aspect of the present invention is actuated by cooperation of electromagnetic force and elastic force. The electromagnetically driven valve includes: a driven valve having a valve shaft and carrying out reciprocating motion along a direction in which the valve shaft extends; first and second oscillating members spaced apart from each other and each having one end coupled to the valve shaft so as to allow free oscillation of the oscillating member and the other end supported by a base member so as to allow free oscillation of the oscillating member; and first and second spring members provided at the other end of the first oscillating member and at the other end of the second oscillating member respectively and applying the elastic force to the first and second oscillating members.

According to the electromagnetically driven valve structured as above, a parallel link mechanism including a plurality of oscillating members is adopted in the rotary drive type in which the driven valve is caused to carry out reciprocating motion as a result of an oscillating movement of the oscillating member. By adopting the parallel link mechanism, the first and second spring members can be arranged at the other ends of the first and second oscillating members respectively, so that it is no longer necessary to secure a space for the first and second spring members along a direction in which the valve shaft extends. Therefore, a length of the electromagnetically driven valve along the direction in which the valve shaft extends (hereinafter, also referred to as the height of the electromagnetically driven valve) can be suppressed, and the electromagnetically driven valve can attain improved mounting characteristic.

Preferably, the driven valve carries out reciprocating motion between a first position and a second position. The first and second spring members apply the elastic force to the first and second oscillating members so that the driven valve is held at a position intermediate between the first position and the second position. According to the electromagnetically driven valve structured as above, the first and second spring members cause the driven valve at the first position or the second position to move toward the intermediate position. That is, the elastic force and the electromagnetic force separately applied can cause the driven valve to reciprocate.

Preferably, the electromagnetically driven valve further includes an electromagnet arranged between the first oscillating member and the second oscillating member and applying the electromagnetic force to the first and second oscillating members. According to the electromagnetically driven valve structured as above, it is only necessary to arrange a single electromagnet between the first oscillating member and the second oscillating member in order to cause the driven valve to reciprocate. Therefore, as compared with an example in which a plurality of electromagnets are arranged in the direction in which the valve shaft extends, the height of the electromagnetically driven valve can be suppressed. In addition, as the number of electromagnets can be reduced, manufacturing cost of the electromagnetically driven valve can be lowered.

An electromagnetically driven valve according to another aspect of the present invention is actuated by cooperation of electromagnetic force and elastic force. The electromagnetically driven valve includes: a driven valve having a valve shaft and carrying out reciprocating motion along a direction in which the valve shaft extends; first and second oscillating members spaced apart from each other and each having one end coupled to the valve shaft so as to allow free oscillation of the oscillating member and the other end supported by a base member so as to allow free oscillation of the oscillating member; and an electromagnet having a monocoil and arranged between the first oscillating member and the second oscillating member. The electromagnetic force is applied to the first and second oscillating members as a result of current flow through the monocoil. It is noted that the “monocoil” herein used refers to a coil implemented by a single continuous line.

According to the electromagnetically driven valve structured as above, a parallel link mechanism including a plurality of oscillating members is adopted in the rotary drive type in which the driven valve is caused to reciprocate as a result of an oscillating movement of the oscillating member. By adopting the parallel link mechanism, it is only necessary to arrange an electromagnet implemented by a monocoil between the first oscillating member and the second oscillating member, so as to cause the driven valve to reciprocate by the electromagnetic force generated by the electromagnet and the elastic force applied separately. Therefore, as compared with an example in which the electromagnet constituted of a plurality of coils is arranged in the direction in which the valve shaft extends, the height of the electromagnetically driven valve can be suppressed, and the electromagnetically driven valve can attain improved mounting characteristic. In addition, manufacturing cost of the electromagnetically driven valve can be lowered by the use of the electromagnet implemented by the monocoil.

Preferably, the electromagnet is configured such that when a direction of a current fed to the monocoil is reversed while any one of the first and second oscillating members is being attracted to the electromagnet, the electromagnetic force acts on any one of the first and second oscillating members that has been attracted to the electromagnet, in a direction away from the electromagnet. According to the electromagnetically driven valve structured as above, performance of the oscillating member to move away from the electromagnet can be improved, and stable oscillating movement and reduction in power consumption can be achieved. In addition, as the electromagnet implemented by the monocoil attains the aforementioned effect, it is not necessary to increase the number of coils.

Preferably, the first and second oscillating members are provided movably with respect to the driven valve so that a distance between a position where one end is coupled to the valve shaft and a position where the other end is supported by the base member is varied. According to the electromagnetically driven valve structured as above, a distance of oscillation of the first and the second oscillating members on one end side is varied in accordance with change in a distance between one end and the other end. Therefore, a mechanism permitting a distance covered in the reciprocating motion of the driven valve to be variable (hereinafter, also referred to as a lift amount of the driven valve) can be obtained in a simplified and facilitated manner.

Preferably, the electromagnetically driven valve further includes a sensor portion detecting an angle of oscillation of the first and second oscillating members with the other end serving as a fulcrum. According to the electromagnetically driven valve structured as above, a distance of oscillation of the first and the second oscillating members on one end side is calculated based on an angle of oscillation of the first and second oscillating members detected by the sensor portion and a stroke of the first and second oscillating members, so that a lift amount of the driven valve can be controlled. Therefore, it is not necessary to provide a sensor, for example, at an end portion of the valve shaft in order to control the lift amount of the driven valve, and the height of the electromagnetically driven valve can further be suppressed.

Preferably, the valve shaft has a buffer member provided between one end of the first oscillating member and one end of the second oscillating member. According to the electromagnetically driven valve structured as above, the buffer member is provided so as to accommodate registration error produced at opposing ends of reciprocating motion of the driven valve. Therefore, the electromagnetically driven valve can achieve desired performance.

As described above, according to the present invention, an electromagnetically driven valve having a smaller height and attaining excellent mounting characteristic can be provided.

### BRIEF DESCRIPTION OF THE DRAWINGS

FIG. 1 is a cross-sectional view showing an electromagnetically driven valve according to a first embodiment of the present invention.

FIG. 2 is a perspective view showing a lower disc (an upper disc) in FIG. 1.

FIG. 3 is a perspective view showing an electromagnet in FIG. 1.

FIG. 4 is a schematic diagram showing the upper disc and the lower disc at a displacement end on a valve-opening side.

FIG. 5 is a schematic diagram showing the upper disc and the lower disc at an intermediate position.

FIG. 6 is a schematic diagram showing the upper disc and the lower disc at a displacement end on a valve-closing side.

FIG. 7 is a graph showing a relation between a lift amount of the driven valve and force acting on the driven valve.

FIG. 8 is a schematic diagram of the electromagnetically driven valve for showing a relation between the lift amount of the driven valve and a distance from one end to the other end of the upper disc.

FIG. 9 is a schematic diagram of an electromagnetically driven valve according to a second embodiment of the present invention.

FIG. 10 is a schematic diagram showing a variation of the electromagnetically driven valve in FIG. 9.

FIG. 11 is a cross-sectional view partially showing an electromagnetically driven valve according to a third embodiment of the present invention.

FIG. 12 is a cross-sectional view showing a state in which a current in a reverse direction is momentarily fed to the electromagnetically driven valve in FIG. 11.

FIG. 13 is a schematic diagram of an electromagnetically driven valve according to a fourth embodiment of the present invention.

### DETAILED DESCRIPTION

Embodiments of the present invention will be described hereinafter with reference to the drawings.

### First Embodiment

The electromagnetically driven valve according to the present embodiment implements an engine valve (an intake valve or an exhaust valve) in an internal combustion engine such as a gasoline engine or a diesel engine. In the present embodiment, description will be given assuming that the electromagnetically driven valve implements an intake valve, however, it is noted that the electromagnetically driven valve is similarly structured also when it implements an exhaust valve.

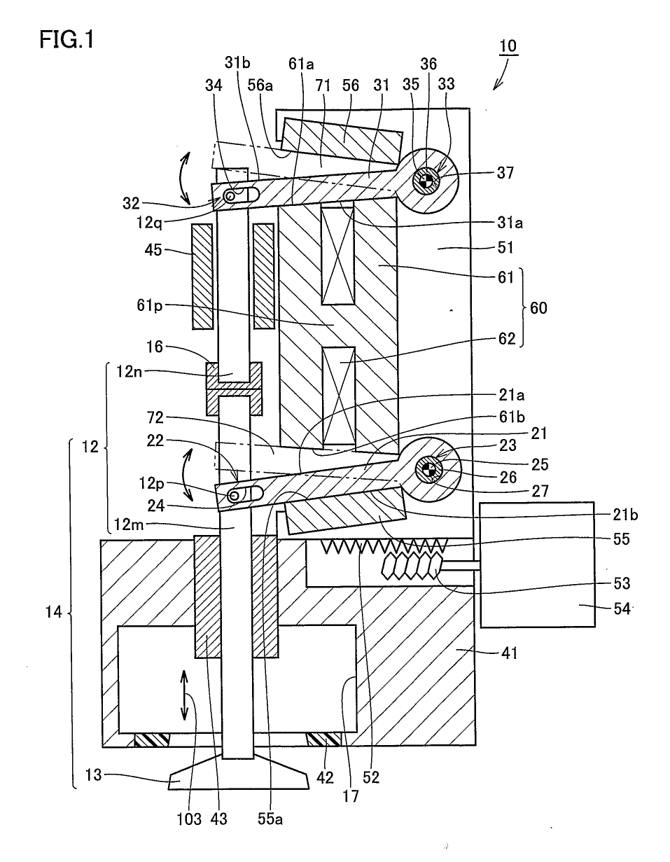

Referring to FIG. 1, an electromagnetically driven valve 10 is a rotary drive type electromagnetically driven valve. As an operation mechanism for the electromagnetically driven valve, a parallel link mechanism is adopted. Electromagnetically driven valve 10 includes a driven valve 14 having a stem 12 extending in one direction, a lower disc 21 and an upper disc 31 oscillating by receiving electromagnetic force and elastic force applied thereto, a valve-opening/closing electromagnet 60 (hereinafter, also simply referred to as electromagnet 60) generating the electromagnetic force, and a lower spring 26 and an upper spring 36 having the elastic force. Driven valve 14 carries out reciprocating motion in the direction in which stem 12 extends (a direction shown with an arrow 103), upon receiving the oscillating movement of lower disc 21 and upper disc 31.

Driven valve 14 is mounted on a cylinder head 41 having an intake port 17 formed. A valve seat 42 is provided in a position where intake port 17 of cylinder head 41 communicates to a not-shown combustion chamber. Driven valve 14 further includes an umbrella-shaped portion 13 formed at an end of stem 12. The reciprocating motion of driven valve 14 causes umbrella-shaped portion 13 to intimately contact with valve seat 42 or to move away from valve seat 42, so as to open or close intake port 17. In other words, when stem 12 is elevated, driven valve 14 is positioned at a valve-closing position. On the other hand, when stem 12 is lowered, driven valve 14 is positioned at a valve-opening position.

Stem 12 is constituted of a lower stem 12m continuing from umbrella-shaped portion 13 and an upper stem 12n connected to lower stem 12m with a lash adjuster 16 being interposed. Lash adjuster 16 with a property more likely to contract and less likely to expand attains a function as a buffer member between upper stem 12n and lower stem 12m. Lower stem 12m has a coupling pin 12p projecting from its outer circumferential surface formed, and upper stem 12n has a coupling pin 12q projecting from its outer circumferential surface formed in a position away from coupling pin 12p.

In cylinder head 41, a valve guide 43 for slidably guiding lower stem 12m in an axial direction is provided, and a stem guide 45 for slidably guiding upper stem 12n in an axial direction is provided in a position away from valve guide 43. Valve guide 43 and stem guide 45 are formed from a metal material such as stainless steel, in order to endure high-speed slide movement with respect to stem 12.

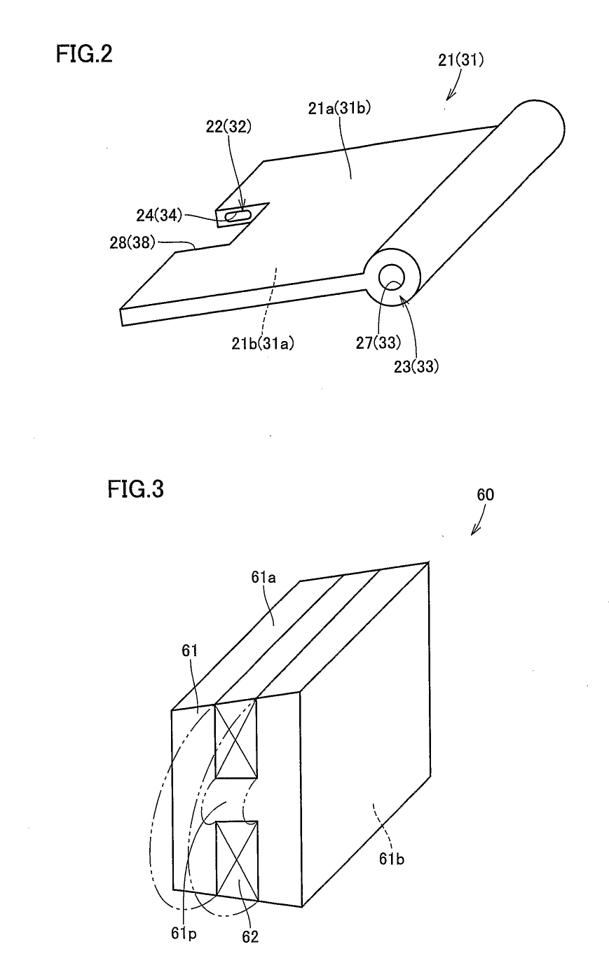

Referring to FIGS. 1 and 2, lower disc 21 has one end 22 and the other end 23, and extends from one end 22 to the other end 23 in a direction intersecting stem 12. On a side of one end 22, lower disc 21 is formed like a flat plate having rectangular surfaces 21a and 21b. On a side of the other end 23, lower disc 21 is formed like a hollow cylinder having a hole 27 formed. Lower disc 21 has a notch 28 formed on the side of one end 22, and elongated holes 24 are formed in opposing wall surfaces of notch 28, respectively.

Upper disc 31 is shaped similarly to lower disc 21, and one end 32, the other end 33, a surface 31b, a surface 31a, a hole 37, a notch 38, and an elongated hole 34 corresponding to one end 22, the other end 23, surface 21a, surface 21b, hole 27, notch 28, and elongated hole 24 of lower disc 21 respectively are formed. Lower disc 21 and upper disc 31 are formed from a soft magnetic material.

One end 22 of lower disc 21 is coupled to lower stem 12m so as to allow free oscillation of the disc by insertion of coupling pin 12p into hole 27. One end 32 of upper disc 31 is coupled to upper stem 12n so as to allow free oscillation of the disc by insertion of coupling pin 12q into hole 37. A disc base 51 extending in parallel to stem 12 is provided on a top surface of cylinder head 41. The other end 23 of lower disc 21 is supported so as to allow free oscillation of the disc around a fulcrum 25 in disc base 51, while the other end 33 of upper disc 31 is supported so as to allow free oscillation of the disc around a fulcrum 35 in disc base 51. With such a structure, lower disc 21 and upper disc 31 oscillate with fulcrums 25 and 35 serving as the center respectively, so as to cause driven valve 14 to reciprocate.

A lower spring 26 and an upper spring 36 are provided at the other ends 23 and 33, respectively. Lower spring 26 applies elastic force to lower disc 21, in a manner moving the same clockwise around fulcrum 25. Upper spring 36 applies elastic force to upper disc 31, in a manner moving the same counterclockwise around fulcrum 35. While the electromagnetic force from electromagnet 60 which will be described later is not yet applied, lower disc 21 and upper disc 31 are positioned by lower spring 26 and upper spring 36 at a position intermediate between a displacement end on a valve-opening side and a displacement end of a valve-closing side.

Referring to FIGS. 1 and 3, electromagnet 60 is provided in disc base 51 at a position between lower disc 21 and upper disc 31. Electromagnet 60 is constituted of a valve-opening/closing coil 62 and a valve-opening/closing core 61 formed from a magnetic material and having attraction and contact surfaces 61a and 61b facing surface 31a of upper disc 31 and surface 21a of lower disc 21 respectively. Valve-opening/closing core 61 has a shaft portion 61p extending in a direction from one end to the other end of lower disc 21 or upper disc 31. Valve-opening/closing coil 62 is provided in a manner wound around shaft portion 61p, and implemented by a monocoil.

Disc base 51 further includes a valve-opening permanent magnet 55, and a valve-closing permanent magnet 56 located on a side opposite to valve-opening permanent magnet 55 with electromagnet 60 being interposed. Valve-opening permanent magnet 55 has an attraction and contact surface 55a facing surface 21b of lower disc 21. A space 72 in which lower disc 21 oscillates is defined between attraction and contact surface 55a and attraction and contact surface 61b of electromagnet 60. In addition, valve-closing permanent magnet 56 has an attraction and contact surface 56a facing surface 31b of upper disc 31. A space 71 in which upper disc 31 oscillates is defined between attraction and contact surface 56a and attraction and contact surface 61a of electromagnet 60.

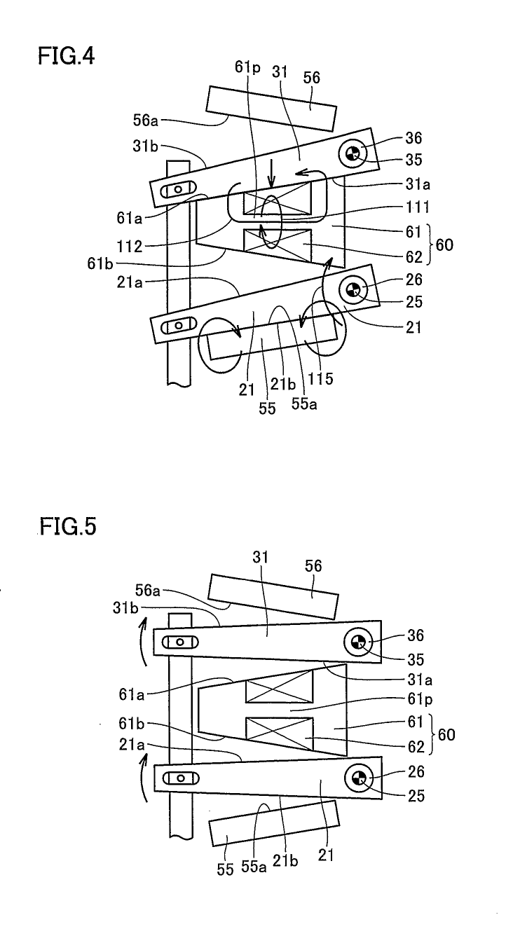

An operation of electromagnetically driven valve 10 will now be described. Referring to FIG. 4, when driven valve 14 is at a valve-opening position, valve-opening/closing coil 62 is supplied with a current flowing in a direction shown with an arrow 111 around shaft portion 61p of valve-opening/closing core 61. Here, on a side where upper disc 31 is located, the current flows from the back toward the front of the sheet showing FIG. 4. Accordingly, magnetic flux flows in valve-opening/closing core 61 in a direction shown with an arrow 112, and the electromagnetic force attracting upper disc 31 toward attraction and contact surface 61a of electromagnet 60 is generated. On the other hand, lower disc 21 is attracted to attraction and contact surface 55a by valve-opening permanent magnet 55. Consequently, upper disc 31 and lower disc 21 resist the elastic force of lower spring 26 arranged around fulcrum 25, and they are held at the displacement end on the valve-opening side shown in FIG. 4.

Referring to FIG. 5, when current supply to valve-opening/closing coil 62 is stopped, the electromagnetic force generated by electromagnet 60 disappears. Then, upper disc 31 and lower disc 21 move away from attraction and contact surfaces 61a and 55a as a result of the elastic force of lower spring 26 respectively, and start to oscillate toward the intermediate position. The elastic force applied by lower spring 26 and upper spring 36 attempts to hold upper disc 31 and lower disc 21 at the intermediate position. Therefore, at a position beyond the intermediate position, force in a direction reverse to an oscillating direction acts on upper disc 31 and lower disc 21 from upper spring 36. On the other hand, as inertial force acts on upper disc 31 and lower disc 21 in the oscillating direction, upper disc 31 and lower disc 21 oscillate as far as the position beyond the intermediate position.

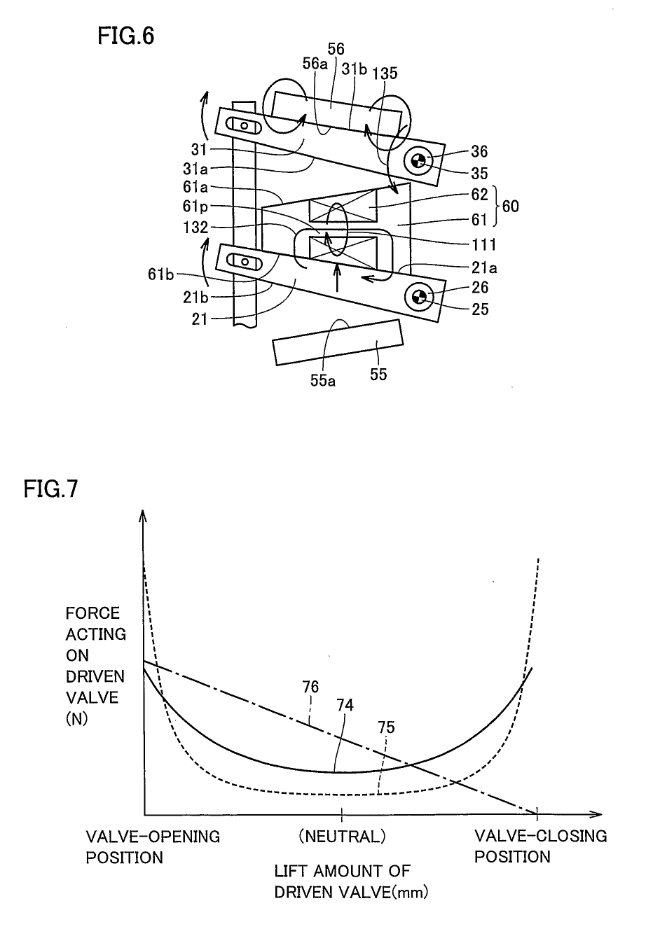

Referring to FIG. 6, at the position beyond the intermnediate position, a current is again fed to valve-opening/closing coil 62 in a direction shown with arrow 111. Here, on a side where lower disc 21 is located, the current flows from the front toward the back of the sheet showing FIG. 6. Accordingly, magnetic flux flows in valve-opening/closing core 61 in a direction shown with an arrow 132, and the electromagnetic force attracting lower disc 21 toward attraction and contact surface 61b of electromagnet 60 is generated. On the other hand, upper disc 31 is attracted to attraction and contact surface 56a by valve-closing permanent magnet 56.

Here, upper disc 31 is also attracted to attraction and contact surface 61a of electromagnet 60 by the electromagnetic force generated by electromagnet 60. Here, the electromagnetic force is stronger between lower disc 21 and electromagnet 60 because a space therebetween is narrow. Therefore, upper disc 31 and lower disc 21 oscillate from the position beyond the intermediate position to the displacement end on the valve-closing side shown in FIG. 6.

Thereafter, current supply to valve-opening/closing coil 62 is repeatedly started and stopped at a timing described above. In this manner, upper disc 31 and lower disc 21 are caused to oscillate between the displacement ends on the valve-opening side and the valve-closing side, so that driven valve 14 carries out the reciprocating motion as a result of the oscillating movement.

As described above, according to the present embodiment, electromagnet 60 implemented by the monocoil is simply provided, so as to cause upper disc 31 and upper disc 21 to oscillate and to cause driven valve 14 to reciprocate. Therefore, as compared with an example in which two electromagnets for valve-opening and valve-closing are provided, the number of expensive parts for the electromagnet can be reduced to half. In addition, as current supply to valve-opening/closing coil 62 is only necessary, the number of circuit elements to be provided in an EDU (electronic driver unit), one circuit element being required for each coil, can also be reduced to half, as in the case of the electromagnet. In the present embodiment, though the description has been given focusing on one intake valve, an internal combustion engine includes a plurality of valves, and each valve requires one electromagnetically driven valve. Therefore, significant cost reduction can be achieved in the internal combustion engine as a whole.

In addition, lash adjuster 16 is provided between upper stem 12n and lower stem 12m in FIG. 1. Lash adjuster 16 is provided so as to accommodate registration error of driven valve 14 at the valve-closing position, as well as to bring umbrella-shaped portion 13 into contact with valve seat 42 in an ensured manner. In the present embodiment, the parallel link mechanism causing lower disc 21 and upper disc 31 to simultaneously oscillate in order to allow reciprocating motion of driven valve 14 is adopted. Actually, however, registration error of driven valve 14 tends to occur due to dimension error or assembly error caused among disc parts. Therefore, providing lash adjuster 16 is particularly effective in electromagnetically driven valve 10 including the parallel link mechanism.

In FIG. 7 showing a relation between a lift amount of the driven valve and force acting on the driven valve, the lift amount of the driven valve at the valve-opening position is assumed as 0 and the lift amount is assumed to increase as the driven valve moves toward the valve-closing position. In addition, in FIG. 7, a solid line 74 represents a relation between the lift amount of driven valve 14 and the electromagnetic force acting on driven valve 14 in electromagnetically driven valve 10 shown in FIG. 1, while a dashed line 76 represents a relation between the lift amount of driven valve 14 and the elastic force of lower spring 26 acting on driven valve 14. Moreover, in FIG. 7, for comparison with electromagnetically driven valve 10 of a rotary drive type, a dotted line 75 represents a relation between the lift amount of the driven valve and the electromagnetic force acting on the driven valve in the electromagnetically driven valve of a parallel drive type.

Referring to FIGS. 1 and 7, in electromagnetically driven valve 10 of a rotary drive type, a distance between fulcrum 25 and a position where the electromagnetic force of electromagnet 60 acts is smaller than a distance between fulcrum 25 and one end 22 of lower disc 21 coupled to driven valve 14, and a distance between fulcrum 35 and a position where the electromagnetic force of electromagnet 60 acts is smaller than a distance between fulcrum 35 and one end 32 of upper disc 31 coupled to driven valve 14. Therefore, as compared with the electromagnetically driven valve of a parallel drive type in which the electromagnets are arranged in series in a direction in which the stem of the driven valve extends and the electromagnetic force directly acts on the driven valve, the electromagnetic force acting on driven valve 14 is smaller at the valve-opening position and the valve-closing position in the electromagnetically driven valve of a rotary drive type.

In addition, at the position intermediate between the valve-opening position and the valve-closing position, in the electromagnetically driven valve of a parallel drive type, the electromagnets are substantially equidistantly placed away from the armature of the driven valve on which the electromagnetic force acts. On the other hand, in electromagnetically driven valve 10 of a rotary drive type, a distance from electromagnet 60 to lower disc 21 becomes smaller toward the other end 23, and a distance from electromagnet 60 to upper disc 31 becomes smaller toward the other end 33. As large electromagnetic force acts at a position where a distance from the electromagnet is small, the electromagnetically driven valve of a rotary drive type can apply larger electromagnetic force to driven valve 14 than the electromagnetically driven valve of a parallel drive type.

As described above, though electromagnetically driven valve 10 of a rotary drive type can achieve large electromagnetic force at the intermediate position, the electromagnetic force becomes weaker at the valve-opening position and the valve-closing position. Accordingly, in the present embodiment, valve-opening permanent magnet 55 for attracting lower disc 21 at the valve-opening position and valve-closing permanent magnet 56 for attracting upper disc 31 at the valve-closing position are provided. As a result of arrangement of these permanent magnets, electromagnetic force insufficient at the valve-opening position and the valve-closing position can be compensated for, so as to prevent increase in power consumption in electromagnet 60. In addition, sufficiently large electromagnetic force can essentially be obtained at the intermediate position, overall power consumption in electromagnet 60 can be reduced.

Electromagnetically driven valve 10 according to the first embodiment of the present invention is actuated by cooperation of the electromagnetic force and the elastic force. Electromagnetically driven valve 10 includes driven valve 14 having stem 12 serving as the valve shaft and carrying out the reciprocating motion along the direction in which stem 12 extends, lower disc 21 and upper disc 31 serving as first and second oscillating members spaced apart from each other and having one ends 22 and 32 coupled to stem 12 so as to allow free oscillation of the disc and the other ends 23 and 33 supported by disc base 51 serving as the base member so as to allow free oscillation of the disc respectively, and lower spring 26 and upper spring 36 serving as the first and second spring members provided at the other end 23 of lower disc 21 and at the other end 33 of upper disc 31 respectively and applying elastic force to lower disc 21 and upper disc 31.

Driven valve 14 reciprocates between the displacement end on the valve-opening side assumed as the first position and the displacement end on the valve-closing side assumed as the second position. Lower spring 26 and upper spring 36 apply the elastic force to lower disc 21 and upper disc 31 so as to hold driven valve 14 at the intermediate position between the displacement end on the valve-opening side and the displacement end on the valve-closing side.

Electromagnetically driven valve 10 is actuated by cooperation of the electromagnetic force and the elastic force. Electromagnetically driven valve 10 includes driven valve 14 having stem 12 and carrying out the reciprocating motion along the direction in which stem 12 extends, lower disc 21 and upper disc 31 spaced apart from each other and having one ends 22 and 32 coupled to stem 12 so as to allow free oscillation of the disc and the other ends 23 and 33 supported by disc base 51 so as to allow free oscillation of the disc respectively, and electromagnet 60 having valve-opening/closing coil 62 implemented by the monocoil and arranged between lower disc 21 and upper disc 31. When a current flows through valve-opening/closing coil 62, the electromagnetic force acts on lower disc 21 and upper disc 31.

Electromagnetically driven valve 10 further includes valve-opening permanent magnet 55 serving as a first permanent magnet and provided on a side opposite to valve-opening electromagnet 60 with lower disc 21 being interposed, and valve-closing permanent magnet 56 serving as a second permanent magnet and provided on a side opposite to valve-opening electromagnet 60 with upper disc 31 being interposed.

According to electromagnetically driven valve 10 in the first embodiment of the present invention structured as above, lower spring 26 and upper spring 36 are provided at the other end 23 of lower disc 21 and at the other end 33 of upper disc 31 respectively. Accordingly, lower spring 26 and upper spring 36 can be arranged at a position apart from stem 12 of driven valve 14, so as to achieve shorter length of stem 12. Therefore, electromagnetically driven valve 10 can be low in height, and electromagnetically driven valve 10 can attain improved characteristic in being mounted on the internal combustion engine. In addition, according to electromagnetically driven valve 10, a single electromagnet 60 arranged between lower disc 21 and upper disc 31 causes lower disc 21 and upper disc 31 to oscillate. Therefore, electromagnetically driven valve 10 can further be low in height.

Electromagnetically driven valve 10 shown in FIG. 1 further includes a mechanism permitting a variable lift amount of driven valve 14. The mechanism permitting a variable lift amount of driven valve 14 will now be described.

Referring to FIG. 1, a motor 54 having a gear 53 is assembled to cylinder head 41. A gear 52 engaged with gear 53 is formed on a bottom surface of disc base 51. Disc base 51 can be moved in a direction orthogonal to the direction in which stem 12 extends, by driving motor 54. Here, electromagnet 60, upper disc 31, lower disc 21, valve-opening permanent magnet 55, and valve-closing permanent magnet 56 also move together. Therefore, by moving disc base 51, a distance between a position where one end 32 of upper disc 31 is coupled to stem 12 and fulcrum 35 where the other end 33 is supported by disc base 51 is varied, and a distance between a position where one end 22 of lower disc 21 is coupled to stem 12 and fulcrum 25 where the other end 23 is supported by disc base 51 is varied.

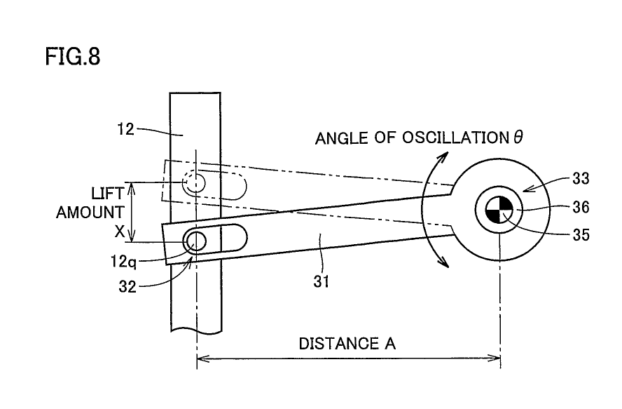

FIG. 8 is a schematic diagram of the electromagnetically driven valve for showing a relation between a lift amount of the driven valve and a distance from one end to the other end of the upper disc. Though the description will be given hereinafter focusing on the upper disc, it is noted that the same description is also applicable to the lower disc. Referring to FIG. 8, it is assumed that a distance between the position where one end 32 is coupled to stem 12 and fulcrum 35 and a lift amount of driven valve 14 are denoted as A and X respectively, and an angle of oscillation of upper disc 31 is denoted as θ. Then, lift amount X is expressed as follows.
X=2×A ×sin(θ/2)
As can be seen from this equation, distance A is varied as a result of movement of disc base 51, and consequently lift amount X of driven valve 14 can be varied. According to such a structure, the mechanism permitting a variable lift amount of driven valve 14 can be implemented without providing a special apparatus for driven valve 14.

A rotation angle sensor for detecting an angle of oscillation θ of upper disc 31 and lower disc 21 may be provided at the other end 33 of upper disc 31 and the other end 23 of lower disc 21. Here, when a travel of disc base 51 is denoted as a, lift amount X is expressed as follows.

X=2×(A+a)×sin(θ/2)

Based on this equation, lift amount X of driven valve 14 can be calculated by using the angle of oscillation θ detected by the rotation angle sensor, and the lift amount of driven valve 14 can be controlled based on the obtained value. As described above, according to the present embodiment, the lift amount of driven valve 14 can be known without directly providing a sensor in driven valve 14. Therefore, the height of electromagnetically driven valve 10 is not increased when the lift amount of driven valve 14 is controlled, and electromagnetically driven valve 10 can still maintain excellent mounting characteristic.

### Second Embodiment

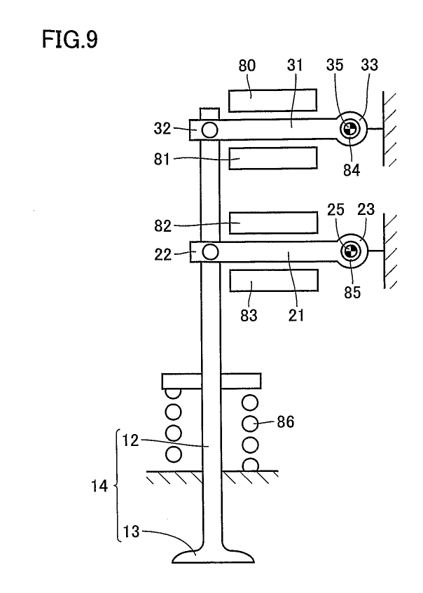

In FIG. 9 showing an electromagnetically driven valve according to a second embodiment of the present invention, the same or corresponding elements as those in electromagnetically driven valve 10 in the first embodiment have the same reference characters allotted. Therefore, description of a redundant structure will not be repeated.

FIG. 9 shows a spring member 86 provided between umbrella-shaped portion 13 and one end 22 of lower disc 21, spring members 85 and 84 provided at the other end 23 of lower disc 21 and at the other end 33 of upper disc 31 respectively, attraction force generation members 82 and 81 provided between lower disc 21 and upper disc 31, an attraction force generation member 83 provided on a side opposite to attraction force generation member 82 with lower disc 21 being interposed, and an attraction force generation member 80 provided on a side opposite to attraction force generation member 81 with upper disc 31 being interposed.

Initially, the second embodiment of the present invention requiring first and second spring members provided at the other ends of the first and second oscillating members respectively as essential constituent features will be described. The electromagnetically driven valve includes a torsion spring at each position of spring members 85 and 84, and a valve spring at a position of spring member 86 in order to compensate for insufficient elastic force. Nevertheless, the torsion springs provided at the positions of spring members 85 and 84 contribute to reduction in size of the valve spring. Therefore, the height of the electromagnetically driven valve can effectively be suppressed. Meanwhile, appropriately combined members that generate attraction force such as an electromagnet or a permanent magnet may be arranged as attraction force generation members 80 to 83, without limited to the manner described in the first embodiment.

The second embodiment of the present invention requiring an electromagnet arranged between the first and second oscillating members as an essential constituent feature will now be described. The electromagnetically driven valve includes an electromagnet at each position of attraction force generation members 81 and 82. On the other hand, when the elastic force can be applied so as to hold driven valve 14 at a prescribed intermediate position, appropriately combined torsion spring and valve spring can be arranged as spring members 84 to 86. For example, a torsion spring moving upper disc 31 counterclockwise around fulcrum 35 is provided at the position of spring member 84, while a valve spring moving stem 12 in a valve-closing direction is provided at the position of spring member 86. At the position of spring member 85, solely a rotation angle sensor is provided, without providing a torsion spring.

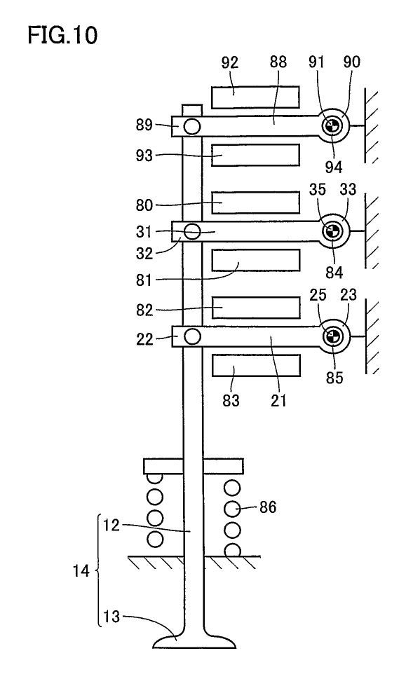

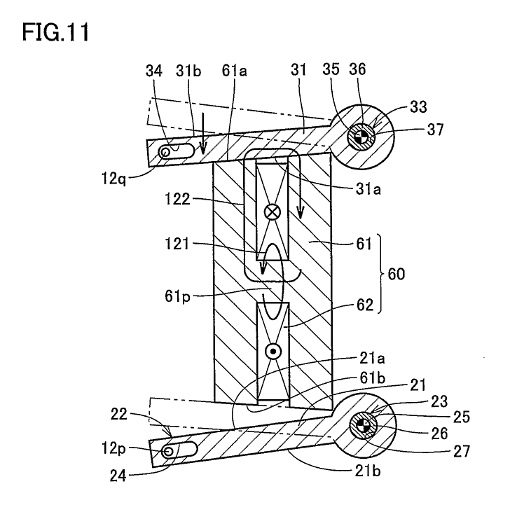

In FIG. 10 showing a variation of the electromagnetically driven valve in FIG. 9, the same or corresponding elements as those in FIG. 9 have the same reference characters allotted. Referring to FIG. 10, the electromagnetically driven valve according to the variation further includes a disc 88 arranged spaced apart from upper disc 31. Disc 88 has one end 89 coupled to stem 12 and the other end 90 provided with a spring member 94 and supported so as to allow free oscillation of the disc around a fulcrum 91. An attraction force generation member 93 is provided adjacent to disc 88, between upper disc 31 and disc 88. An attraction force generation member 92 is provided on a side opposite to attraction force generation member 93 with disc 88 being interposed.

The present invention is also applicable to the electromagnetically driven valve including three or more discs serving as the oscillating members. In this case as well, in order to meet the requirement of the present invention, a torsion spring, an electromagnet, a permanent magnet, and the like may appropriately be arranged at positions of the spring member and the attraction force generation member shown in the drawing.

According to the electromagnetically driven valve in the second embodiment of the present invention structured as above, an effect similar to that in the first embodiment can be obtained.

### Third Embodiment

An electromagnetically driven valve according to the present embodiment is structured in a manner similar to electromagnetically driven valve 10 in the first embodiment, however, a method of supplying the electromagnet with a current is different.

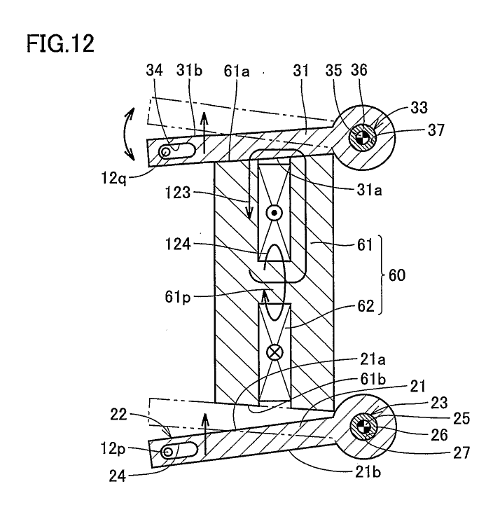

Referring to FIG. 11, valve-opening/closing coil 62 is supplied with a current flowing in a direction shown with an arrow 121 around shaft portion 61p of valve-opening/closing core 61. Here, magnetic flux flows in valve-opening/closing core 61 in a direction shown with an arrow 122, and upper disc 31 is attracted toward attraction and contact surface 61a of electromagnet 60. Referring to FIG. 12, in the present embodiment, in a state shown in FIG. 11, a direction of the current fed to valve-opening/closing coil 62 is reversed. In other words, a current flowing in a direction shown with an arrow 124 around shaft portion 61p of valve-opening/closing core 61 is momentarily supplied to valve-opening/closing coil 62.

By reversing the direction of current feed, the direction of flow of magnetic flux is reversed. Therefore, magnetic flux flows in valve-opening/closing core 61 in a direction shown with an arrow 123. Then, repulsive force is generated between upper disc 31 and electromagnet 60, so that upper disc 31 can more readily be moved away from attraction and contact surface 61a. Thereafter, as in the method described in the first embodiment, current supply to electromagnet 60 is stopped, so as to cause upper disc 31 to oscillate to the intermediate position. When lower disc 21 is attracted to attraction and contact surface 61b of electromagnet 60 as well, the direction of current feed is reversed in a similar manner.

According to the electromagnetically driven valve in the third embodiment of the present invention structured as above, an effect similar to that in the first embodiment can be obtained. In addition, upper disc 31 and lower disc 21 are more readily moved away from electromagnet 60, so that the oscillating movement of the disc can be stabilized. Moreover, power consumption in electromagnet 60 can further be reduced.

### Fourth Embodiment

An electromagnetically driven valve according to the present embodiment is structured basically in a manner similar to electromagnetically driven valve 10 in the first embodiment. Therefore, description of a redundant structure will not be repeated.

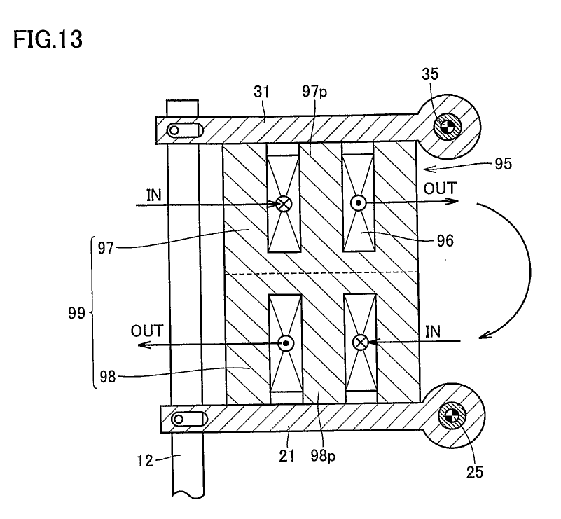

Referring to FIG. 13, in the present embodiment, an electromagnet 95 is arranged between lower disc 21 and upper disc 31. Electromagnet 95 includes a core 99 constituted of a combination of portions 97 and 98 each having a substantially E-shaped cross-section and a coil 96 implemented by a monocoil. Coil 96 is provided in core 99 in such a manner that the coil is wound around a shaft portion 97p of portion 97 and around a shaft portion 98p of portion 98.

According to the electromagnetically driven valve in the fourth embodiment of the present invention structured as above, an effect similar to that in the first embodiment can be obtained. In addition, larger electromagnetic force can be applied to lower disc 21 and upper disc 31 by means of electromagnet 95.

The structures of the electromagnetically driven valve described in the first to fourth embodiments may appropriately be combined so as to implement another electromagnetically driven valve.

Although the present invention has been described and illustrated in detail, it is clearly understood that the same is by way of illustration and example only and is not to be taken by way of limitation, the spirit and scope of the present invention being limited only by the terms of the appended claims.

### INDUSTRIAL APPLICABILITY

The present invention is mainly utilized as an intake valve or an exhaust valve in a gasoline engine, a diesel engine, or the like.

1. An electromagnetically driven valve actuated by cooperation of electromagnetic force and elastic force, comprising:
a driven valve having a valve shaft and carrying out reciprocating motion along a direction in which said valve shaft extends;
first and second oscillating members spaced apart from each other and each having one end coupled to said valve shaft so as to allow free oscillation of the oscillating member and the other end supported by a base member so as to allow free oscillation of the oscillating member;
first and second spring members provided at said other end of said first oscillating member and at said other end of said second oscillating member respectively and applying said elastic force to said first and second oscillating members; and
an electromagnet arranged between said first oscillating member and said second oscillating member and applying said electromagnetic force to said first and second oscillating members.

2. The electromagnetically driven valve according to claim 1, wherein
said driven valve carries out reciprocating motion between a first position and a second position, and
said first and second spring members apply said elastic force to said first and second oscillating members so that said driven valve is held at a position intermediate between said first position and said second position.

3. (canceled)

4. The electromagnetically driven valve according to claim 1, wherein
said first and second oscillating members are provided movably with respect to said driven valve so that a distance between a position where said one end is coupled to said valve shaft and a position where said other end is supported by the base member is varied.

5. The electromagnetically driven valve according to claim 4, further comprising a sensor portion detecting an angle of oscillation of said first and second oscillating members with said other end serving as a fulcrum.

6. The electromagnetically driven valve according to claim 1, wherein
said valve shaft has a buffer member provided between said one end of said first oscillating member and said one end of said second oscillating member.

7. An electromagnetically driven valve actuated by cooperation of electromagnetic force and elastic force, comprising:
a driven valve having a valve shaft and carrying out reciprocating motion along a direction in which said valve shaft extends;
first and second oscillating members spaced apart from each other and each having one end coupled to said valve shaft so as to allow free oscillation of the oscillating member and the other end supported by a base member so as to allow free oscillation of the oscillating member; and
an electromagnet having a monocoil and arranged between said first oscillating member and said second oscillating member; wherein
said electromagnetic force is applied to said first and second oscillating members as a result of current flow through said monocoil.

8. The electromagnetically driven valve according to claim 7, wherein
said electromagnet is configured such that when a direction of a current fed to said monocoil is reversed while any one of said first and second oscillating members is being attracted to said electromagnet, said electromagnetic force acts on any one of said first and second oscillating members that has been attracted to said electromagnet, in a direction away from said electromagnet.

9. The electromagnetically driven valve according to claim 7, wherein
said first and second oscillating members are provided movably with respect to said driven valve so that a distance between a position where said one end is coupled to said valve shaft and a position where said other end is supported by the base member is varied.

10. The electromagnetically driven valve according to claim 9, further comprising a sensor portion detecting an angle of oscillation of said first and second oscillating members with said other end serving as a fulcrum.

11. The electromagnetically driven valve according to claim 7, wherein
said valve shaft has a buffer member provided between said one end of said first oscillating member and said one end of said second oscillating member.
